(19) United States
(12) Patent Application Publication
(10) Pub. No.: US 2007/0059394 A1
(43) Pub. Date: Mar. 15, 2007

(54) Nail Surface Mold Enclosure

(76) Inventors: Scott L Nielson, Layton, UT (US); Craig P Gifford, West Jordan, UT (US)

Correspondence Address: SCOTT NIELSON, 1076 WALBURK AVE, LAYTON, UT, 84040, US

(21) Appl. No.: 11/162,430

(22) Filed: Sep. 9, 2005

(51) Int. Cl. B28B 1/00

(52) U.S. Cl. 425/2

(57) ABSTRACT

A nail surface mold enclosure is shown making it easy in preparing mold impressions of a natural nail surface. The enclosure may be of various sizes to fit the largest of nail surfaces. This enclosure simplifies the process of taking accurate and predictable impressions of a desired natural nail surface so that an average consumer can successfully create the desired impression result. The enclosure provides rigidity to impression molding material. Holes are placed on the infusing end of the enclosure to insure that the impression molding material adequately covers the entire nail surface and excess material is exposed through these holes thus preventing voids or inverted pressure gaps. The result of the nail surface mold enclosure is the easy collection of a desired impression of the natural nail surface. While the invention has many applications, it is anticipated that it will be easier to acquire impressions of natural finger and toe nail surfaces.

### FIELD OF THE INVENTION

The present invention relates to custom fit artificial nails and, more specifically, to a nail surface mold enclosure permitting a natural nail surface to be cast in an individual mold, which can be used later for the creation of a customized artificial nail product.

### BACKGROUND AND RELATED ART

Artificial nails (fingernails and toenails) typically comprise thin, elongated, plastic structures having a configuration substantially similar to a real fingernail. Through use of an adhesive, the artificial fingernails can be selectively secured to existing fingernails. One of the benefits of artificial nails is that they enable a user to selectively have uniform nails of a desired thickness, length, and configuration without having to wait for the real nails to grow. This is especially useful to those who have weak nails that easily crack or break.

One method of applying artificial nails used in nail salons involves a time-consuming and laborious process of applying an acrylic to each natural nail surface. After the application of the acrylic the artificial nail is shaped by a nail technician. The above process requires one skilled in application of acrylic and the results are generally improved with experience. Another method involves the application of prefabricated nails. These prefabricated nails are painstakingly shaped to fit the cuticle end of the natural nail surface. The problem with this approach is that each nail surface has its own unique curvature and arch that a prefabricated artificial nail simply cannot anticipate. Additionally, the prefabricated nails are made from materials that are not reusable thus requiring the process of shaping to be repeated each time a desire for artificial nails is presented.

The solution to the current problems in the field of artificial nails is to create a customized artificial nail product composed of material that allows the customized product to be reused. This solution is presented by U.S. Pat. No. 5,968,302 and U.S. Pat. No. 6,196,234. These patents are directed to precision fit nails and methods for manufacturing precision fit nails. The precision fit nails described in these patents address many of the problems described above because they are made using models of real nails to cast acetone resistant thermoplastic artificial nails with a bottom surface that closely matches the top surface of the corresponding real nails. However, the processes of measuring for and manufacturing precision fit nails in accordance with U.S. Pat. No. 5,968,302 and U.S. Pat. No. 6,196,234 are somewhat complex and generally require a substantial amount of specialized skill and labor.

### BRIEF DESCRIPTION OF DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 is a drawing showing the nail mold enclosure.

FIG. 2 is a drawing showing the process a consumer would go through in creating a nail surface mold by using the nail mold enclosure.

### DETAILED DESCRIPTION

The present invention is directed to simplifying the process of taking impression molds of a natural nail surface by supplying a unique nail surface mold enclosure which permits a consumer to easily snap over their finger or toe, resulting in a successful mold of their nail surface. Once the mold enclosures have been completed and returned to the manufacturing facility, the impression molds can then be imaged, creating a three dimensional surface permitting the creation of a customized reusable artificial nail product for the consumer. In the description that follows, tasks may be described in a sequence that has been selected to facilitate an understanding of the disclosed embodiments of the invention. It should be clear, however, that in practicing the invention, many tasks may be performed in an arbitrary order, and therefore any particular order implied by the description usually represents one of many possibilities.

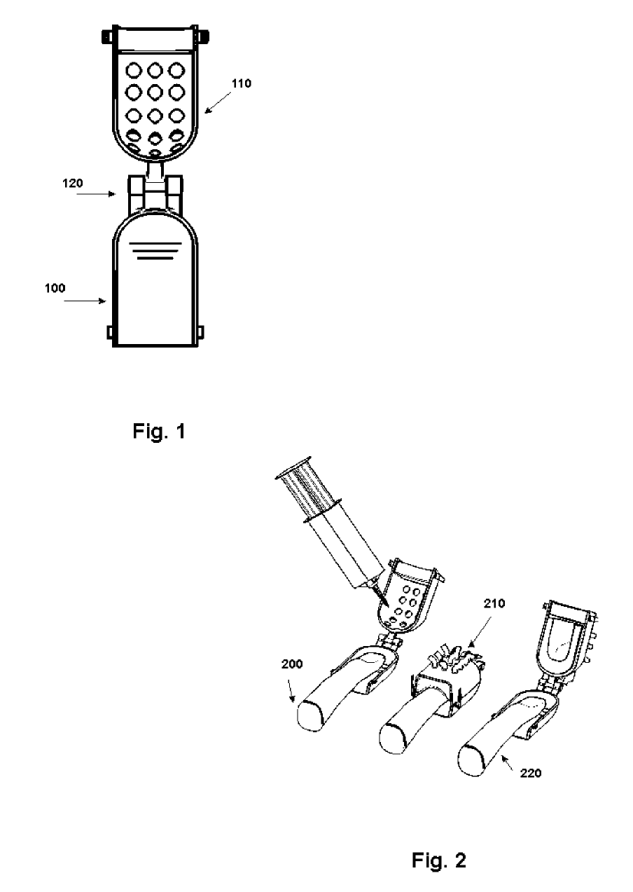

FIG. 1 shows the preferred representation of the nail surface mold enclosure. The invention shows a bottom section 100, which is shaped to allow a finger or toe to be placed into the enclosure. Then the top section 110 is shown, which will be fit over the bottom section 100. Finally, a fastener 120 is shown demonstrating how the top section 110 and bottom section 100 are to be held together while the impression mold material is cured.

The invention is used by infusing enough mold impression material 200 into the top section 110 or distributing enough mold impression material directly upon the natural nail surface and then placing the finger 210 into the bottom section 100. Once the impression process is started the consumer presses the top section 110 onto or over 210 the bottom section 100 and then waits until the molding material has cured. The fastener 120 holds the impression material in place over the nail surface until cured. After the impression material has cured, the top section 110 can be opened and the finger removed leaving a desired mold representing the natural nail surface 220.

The holes in the top section 110 ingeniously permit excess impression molding material to escape without exerting excess back pressure on the finger or toe, thus preventing inverse gaps. Additionally, voids are avoided as the top section 110 is marked to show the consumer how much impression molding material is necessary to insure a desired outcome and a mold of the natural nail surface.

The result of this invention is the easy collection of desired impression molds of natural nail surfaces. These impressions can be taken by the average consumer and the results are usable in generating a customized artificial nail product for the individualized consumer.

The present invention overcomes prior art as described above in simplifying the process of taking impression molds of a natural nail surface. There is no requirement for specialized knowledge or skill in preparing the molds as the invention presents a simplified approach by providing a nail surface mold enclosure specifically designed to take nail surface molds. The laborious and time consuming tasks presented by the prior art are overcome by providing the consumer with an easy to understand invention inclusive of all the functionality needed to create the desired impression mold of the desired nail surface. The present invention presents a real and recognizable time savings over the prior art.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A nail surface mold enclosure comprising:
a container shaped to allow a finger or toe to fit comfortably within the bottom of the container; and a top of the container that fits onto the bottom of the container; and an optional fastener attached on the opposite end of where the finger enters the container.

2. A nail surface mold enclosure according to claim 1, wherein said nail surface mold enclosure may be of various sizes permitting a fit around a variety of natural nail surfaces.

3. A nail surface mold enclosure according to claim 2, wherein natural nail surfaces include fingernails and toenails.

4. A nail surface mold enclosure according to claim 2, wherein various size mold enclosures are large enough to fit over any natural nail surface.

5. A nail surface mold enclosure according to claim 2, wherein said nail surface mold enclosure will permit adequate mold impression material to be infused to achieve the goal of creating a mold of the natural nail surface.

6. A nail surface mold enclosure according to claim 1, wherein said top of the container is designed with holes placed to permit excess mold impression material to escape through the top of the enclosure.

7. A nail surface mold enclosure according to claim 6, wherein the holes in the top of the enclosure are positioned so as to maintain rigidity and support for the mold impression material.

8. A nail surface mold enclosure according to claim 6, wherein the top portion of the enclosure is designed to fit on top of the bottom enclosure. However, this design characteristic may be modified by permitting the top or bottom to fit into the other portion of the enclosure.

9. A nail surface mold enclosure according to claim 1, wherein the optional fastener is used to bind the top and bottom sections of the enclosure so that an impression of the natural nail surface may be achieved without disruption from finger or toe movement.

10. A nail surface mold enclosure according to claim 1, wherein the optional fastener may be omitted entirely if the top and bottom sections are designed to fit or snap into each other.
